(19) United States
(12) Patent Application Publication
(10) Pub. No.: US 2026/0267153 A1
(43) Pub. Date: Sep. 10, 2026

(54) SYSTEMS AND METHODS FOR DISPLAY BINOCULAR DEFORMATION COMPENSATION

(71) Applicant: Magic Leap, Inc., Plantation, FL (US)

(72) Inventors: Aaron Mark SCHUELKE, Coral Springs, FL (US); Alejandro LOPEZ, Pembroke Pines, FL (US); Bach NGUYEN, Coral Springs, FL (US); Jason Donald MARENO, Raleigh, NC (US); Sebastian KULESSA, Lauderdale by the Sea, FL (US); Michael Derek ABBOTT, Weston, FL (US); Charles Robert SCHABACKER, Plantation, FL (US); Chuanyang FAN, Plantation, FL (US)

(73) Assignee: Magic Leap, Inc., Plantation, FL (US)

(21) Appl. No.: 18/875,437

(22) PCT Filed: Jun. 15, 2023
(86) PCT No.: PCT/US2023/068550

§ 371 Date: Dec. 16, 2024

Related U.S. Application Data
(60) Provisional application No. 63/353,427, filed on Jun. 17, 2022.

(51) Int. Cl. G02B 27/01; G02C 1/04; G02C 5/06

(52) U.S. Cl. CPC G02B 27/0176; G02B 27/0179; G02C 1/04; G02C 5/06; G02B 2027/0132; G02B 2027/0178; G02C 2200/16

(57) ABSTRACT

An eyewear device for being worn on a head of a user for presenting virtual content to a user comprises a frame structure having a frame front, and an optical assembly having a first rigidity. The optical assembly has a chassis and a plurality of optical components affixed to the chassis. The eyewear device further comprises a plurality of mounts mechanically coupling the chassis of the optical assembly to the frame front, at least one of the plurality of mounts having a second rigidity less than the first rigidity, such that the mount(s) is configured for preventing at least a portion of a first static deformation load applied to the frame front from being mechanically communicated to the optical assembly.

### INCORPORATION BY REFERENCE

This application claims priority to U.S. Provisional Application Ser. No. 63/353,427, filed on Jun. 17, 2022, the contents of which are hereby expressly and fully incorporated by reference in its entirety.

### TECHNICAL FIELD

This disclosure generally relates to eyewear devices and, more particularly, to improved designs of eyewear devices that include optics and/or electronics, such as head-mounted displays (HMDs).

### BACKGROUND

Eyewear devices, such as head-mounted displays (HMDs), having optics and/or electronics (e.g., spatial computing headsets). As one example, HMDs may take the form of so-called extended reality (XR) headsets that create an environment for a user in which some or all of the environment is generated by presenting digitally reproduced images (e.g., virtual objects) to a user in a manner where they seem to be, or may be perceived as, real. XR headsets may be useful for many applications, spanning the fields of scientific visualization, medical training, engineering design and prototyping, tele-manipulation and tele-presence, and personal entertainment. An XR headset may include, e.g., a virtual reality (VR) headset, an augmented reality (AR) headset, or a mixed reality (MR) headset. A VR headset typically involves presentation of virtual objects to a user without transparency to other actual real-world visual input, whereas an AR or MR system typically involves presentation of virtual objects to a user in relation to real objects of the physical world.

Some eyewear devices include optics that are much more complex than conventional eyeglasses and are thus heavier, especially towards the frame front of the eyewear devices. For example, some eyewear devices employ an opaque visor having one or more LCD (liquid crystal display) panels as the “lenses” for the eyewear devices to display digital contents. Some eyewear devices even contain the provisioning for mounting a smart phone, so that users may view the contents on the smart phone display through the lenses of these eyewear devices. Some other more advanced eyewear devices, such AR headsets, employ transparent or at least translucent lenses to allow the users to perceive the physical environment around them and may directly project digital contents to the eyes of the user to blend the digital contents with the physical environment, rather than displaying digital contents on a screen that occludes or obstructs the user's view of the physical environment.

One challenge is that eyewear devices may suffer from various instability issues due to deformations or deflection of, for example, the frame structure (e.g., the frame front that houses the optics or the temple arms or headband that stably position the eyewear devices on the head of the user) of an eyewear device from manipulations, such as fitting these eyewear devices on users' head of various different sizes and shapes, handling the eyewear devices, etc. Such deformations or deflections of the frame structure may transfer loads to delicate optics (e.g., eyepieces, light projectors, cameras, etc.) and other non-optical components (e.g., head position sensors, such as one or more Inertial Measurement Units (IMUs)) carried by the frame structure, such that they deviate from their intended or as-designed position(s) or even fall outside a permissible range, such that the performance and/or user experience of the eyewear device is hindered. This instability issue may be exacerbated by the fact that eyewear devices usually adopt structures or components made of light-weight materials to facilitate transportation, comfort, and a more aesthetically-pleasing look. Such light-weight materials may be more susceptible to mechanical bending, torsion, etc., arising from manipulations of the eyewear devices and/or fit of the eyewear devices on users and causing deformations or deflections in the eyewear devices. Furthermore, eyewear devices often have large holes (e.g., for mounting of eyepieces) and nasal cutouts further exacerbating the instability issue.

Deformation of an eyewear device may be categorized into two groups: monocular, which occurs when an individual optical element (e.g., an eyepiece bends) and binocular, which occurs when optical elements (e.g., a left eyepiece and a right eyepiece) translate and/or rotate relative to each other.

For example, referring to FIG. 1, monocular deformation of an eyewear device is a function of mounting the optical components onto the frame structure. In particular, an exemplary eyewear device 1 may have a rigid frame structure 2 and an optical assembly 3 (including a rigid chassis 4 and a pair of left and right eyepieces 5 (only one shown) that is joined to a portion of the frame structure 2, and in particular, a frame front 6 of the frame structure 2, using a screw 7. Due to variation and tolerances, a mismatch at an interface 8 between the frame front 6 and optical assembly 3 occurs, which results in a single contact point 9 between the frame front 6 and optical assembly 3 that is some radial distance away from the load of the screw 7 (the axial screw force) that is used to join the frame front 6 and optical assembly 3 together. As a result, a torque equal to the product of the screw force load and the distance between the contact point 9 and the screw 7 is created at a bending moment (corresponding to the contact point 9) into the frame front 6, which deforms the eyepiece 5 in undesirable ways.

Binocular deformation of an eyewear device may occur as a result of a load being transferred into the frame structure from user interaction with the eyewear device (e.g., with the temple arms, headband or frame front), and then into the chassis of the optical assembly, which elastically deforms the chassis, causing the optical components (e.g., the left and right eyepieces, as well as other optical components, such as left and right light projectors, left and right world-view cameras, left and right eyeball tracking cameras etc.) to translate and/or rotate relative to each other.

For example, an eyewear device may comprise a pair of binocularly-aligned left and right eyepieces 5L, 5R, as illustrated in FIG. 2. Although each eyepiece 5L, 5R may be internally rigid to a certain extent, in such implementations, the two eyepieces 5L, 5R may be flexible/deformable relative to one another by virtue of the form factor of the frame structure (not shown in FIG. 2) to which the two eyepieces 5L, 5R are mounted. Distortion of the frame structure may cause relative moment of the eyepieces 5L, 5R, thereby introducing distortion and other error into a virtual binocular image that is to be projected onto the user's retina.

For example, as illustrated in FIGS. 3A-3D, an exemplary representation of virtual content may be presented and perceived through the pair of eyepieces 5L, 5R to left and right eyes, respectively, as part of the eyewear device. As shown in FIG. 3A, the two eyepieces 5L, 5R are aligned with one another in an ideal manner. In other words, the alignment of the two eyepieces 5L, 5R has not changed since the time of manufacture of the eyewear device. Thus, the eyewear device may generate and present left and right monocular virtual content VC_{L}, VC_{R} as a binocularly-aligned virtual content VC through the two eyepieces 5L, 5R to the user's eyes. However, if the alignment of the two eyepieces 5L, 5R were to hypothetically change some point after the time of manufacture of the eyewear device, the alignment of the pair of eyepieces 10L, 10R in each of FIGS. 3B, 3C, and 3D may differ from that of FIG. 3A. Post-factory changes in the alignment of the pair of eyepieces 5L, 5R about the Pitch-axis, the Roll-axis, and the Yaw-axis, could result in left and right virtual content 10L, 10R being presented and perceived through the pair of eyepieces 5L, 5R as binocularly misaligned virtual content VC, as respectively shown in FIGS. 3B, 3C, and 3D. Furthermore, studies show that binocular misalignments can cause physiological strain on the human visual system, and that humans are sensitive to binocular rotational misalignment of virtual images about the Pitch, Roll, and Yaw axes down to 4, 6, and 10 arcminutes, respectively. Relative translation and rotation between the light projectors, world-view cameras, and eyeball tracking cameras caused by the distortion of the frame structure may also result in undesirable effects.

While deformation of a frame structure of an eyewear device may be unavoidable, prior art techniques have mechanically isolated the optical assembly from the frame structure, such that the optical assembly does not deform in response to deformation of the frame structure. For example, with reference to FIGS. 4A and 4B, one known technique for mechanically isolated an optical assembly 3 from a frame structure 2 of eyewear device 1 affixes the rigid chassis 4 to the center of the frame front 6 of the frame structure 2 via a single rigid mount 7 (e.g., a screw). Because the optical assembly 3 is in mechanical communication with the frame front 6 at only one point, any deformation of the frame front 6 will not translate a load through the single rigid mount 7 to the rigid chassis 4 of the optical assembly 3. However, because the chassis 4 is only mounted to the frame front 6 at one point, the chassis 4 is susceptible to bend (i.e., flow around) in response to an inertial force (e.g., caused by quick movements of the user's head) applied to the optical assembly 3. As a result, the optical components distributed on the chassis 4 will translate and/or rotate relative to each other, with this adverse effect increasing as the distance between any particular optical component and the rigid mount 7 increases.

There, thus, remains an improved means for mechanically isolating an optical assembly from a frame structure of an eyewear device to prevent or minimize monocular and/or binocular distortion of the optical assembly.

### BRIEF DESCRIPTION OF DRAWINGS

The drawings illustrate the design and utility of embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a cross-sectional view of a prior art mechanism for mounting an optical assembly to a frame front of a frame structure, resulting in monocular deformation of the optical assembly;

FIG. 2 is a plan view of left and right eyepieces may be used in the optical assembly of FIG. 1;

FIG. 3A is a plan view of the left and right eyepieces of FIG. 2, wherein the left and right eyepieces are aligned in an ideal manner;

FIG. 3B is a plan view of the left and right eyepieces of FIG. 2, wherein the left and right eyepieces are rotationally-misaligned about the Pitch-axis;

FIG. 3C is a plan view of the left and right eyepieces of FIG. 2, wherein the left and right eyepieces are rotationally-misaligned about the Roll-axis;

FIG. 3D is a plan view of the left and right eyepieces of FIG. 2, wherein the left and right eyepieces are rotationally-misaligned about the Yaw-axis;

FIG. 4A is a front view illustrating one prior art technique for mechanically isolating an optical assembly from the frame front of a frame structure;

FIG. 4B is a profile view illustrating the prior art technique of FIG. 4A;

FIG. 5 is a plan view of an extended reality (XR) system constructed in accordance with one embodiment of the present inventions;

FIG. 6 is a top view of a head-mounted display (HMD) of the XR system of FIG. 5;

FIG. 7 is a front view of the HMD of FIG. 6;

FIG. 8 is a perspective view of the HMD of FIG. 6;

FIG. 9 is a top view of the HMD of FIG. 6, particularly showing internal components of the HMD;

FIG. 10 is an exploded view of the HMD of FIG. 6;

FIG. 11 is a perspective view of an optical assembly of the HMD of FIG. 6;

FIG. 12A is a rear view of the HMD of FIG. 6, particularly showing the application of a twist load to the HMD;

FIG. 12B is a rear view of the HMD of FIG. 6, particularly showing the application of a vertical pull load to the HMD;

FIG. 12C is a top view of the HMD of FIG. 6, particularly showing the application of a temple spread load to the HMD;

FIG. 13A is a perspective view of a frame front of the HMD of FIG. 6, particularly showing a lack of deformation of the frame front in the absence of the application of a static deformation load on the frame front;

FIG. 13B is a perspective view of an optical assembly of the HMD of FIG. 6, particularly showing a lack of deformation of the optical assembly in the absence of the application of a static deformation load on the frame front;

FIG. 14A is a perspective view of a frame front of the HMD of FIG. 6, particularly showing deformation of the frame front in the presence of the application of the static deformation load on the frame front;

FIG. 14B is a perspective view of the optical assembly of the HMD of FIG. 6, particularly showing deformation of the optical assembly in the presence of the application of a static deformation load on the frame front;

FIG. 15 is a perspective view of a portion of the HMD of FIG. 6, particularly showing a location of flexible mounts for affixing the optical assembly to the frame front of the HMD;

FIG. 16A is a representative planar diagram of the frame front and optical assembly of the HMD of FIG. 6, particularly showing a nominal position of the optical assembly relative to the frame front in the absence of the application of a static deformation load to the frame front;

FIG. 16B is a representative planar diagram of the frame front and optical assembly of the HMD of FIG. 6, particularly showing a new position of the optical assembly relative to the frame front in the presence of the application of the static deformation load to the frame front;

FIG. 16C is a representative planar diagram of an alternative embodiment of the frame front and optical assembly of the HMD of FIG. 6, particularly showing a nominal position of the optical assembly relative to the frame front in the absence of the application of a static deformation load to the frame front;

FIG. 16D is a representative planar diagram of the alternative embodiment of the frame front and optical assembly of the HMD of FIG. 6, particularly showing a new position of the optical assembly relative to the frame front in the presence of the application of the static deformation load to the frame front;

FIG. 17 is a close-up view of a flexible mount used to affix the optical assembly to the frame front of the HMD of FIG. 6;

FIG. 18 is a cross-sectional view of the HMD of FIG. 7, taken along the line 18-18;

FIG. 19 is a close-up view of a flexible mount and a rigid stop assembly in the HMD of FIG. 18;

FIG. 20 is a cross-sectional view of the flexible mount and rigid stop assembly of FIG. 19;

FIG. 21 is a perspective view of an optical assembly of the HMD of FIG. 6, particularly showing the location of rigid stop assemblies;

FIG. 22 is a close-up view of an x-y stop of a rigid stop assembly located on a peripheral of the HMD of FIG. 21;

FIG. 23 is a close-up view of a z stop of a rigid stop assembly of the HMD of FIG. 21;

FIG. 24 is a close-up view of a rigid stop assembly located on a bridge portion of the HMD of FIG. 21; and

FIG. 25 is a cross-sectional view of the rigid stop assembly of FIG. 24.

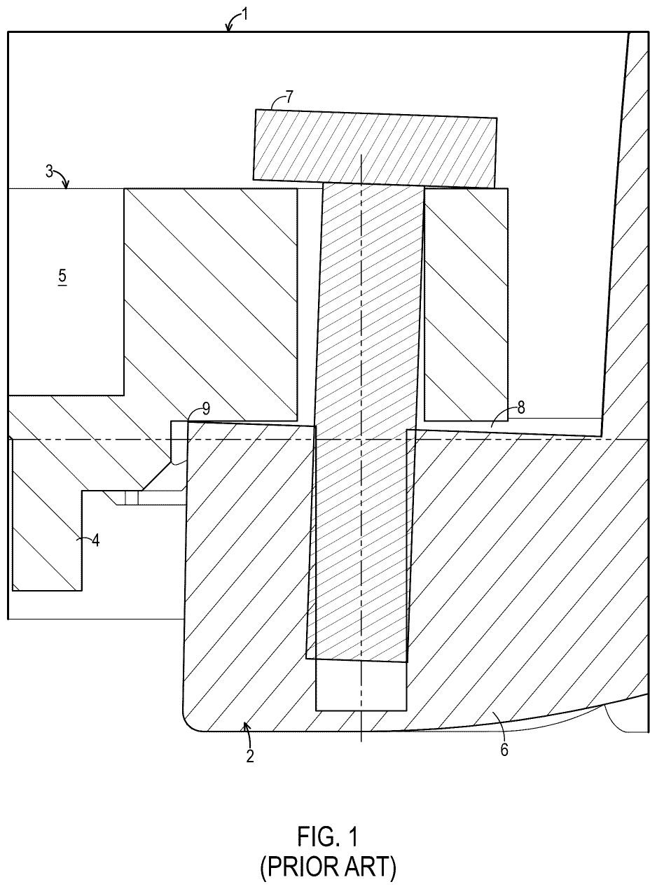

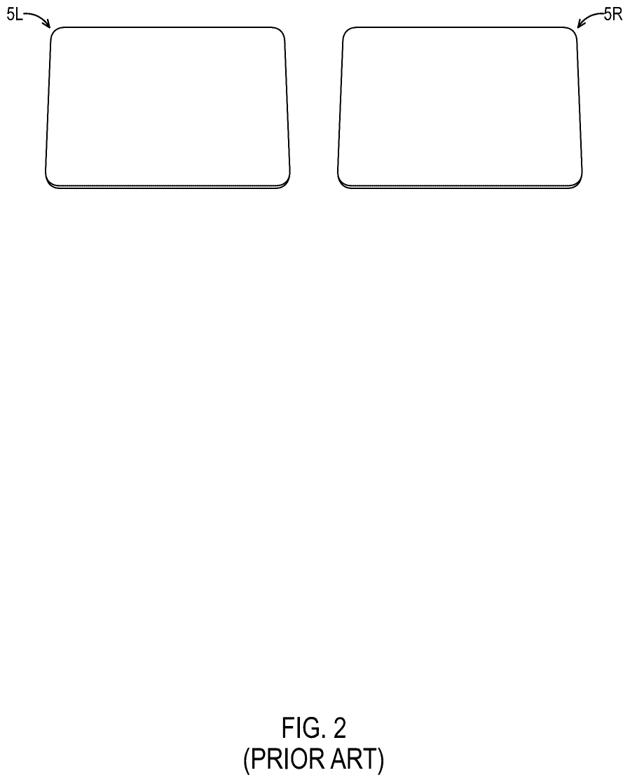

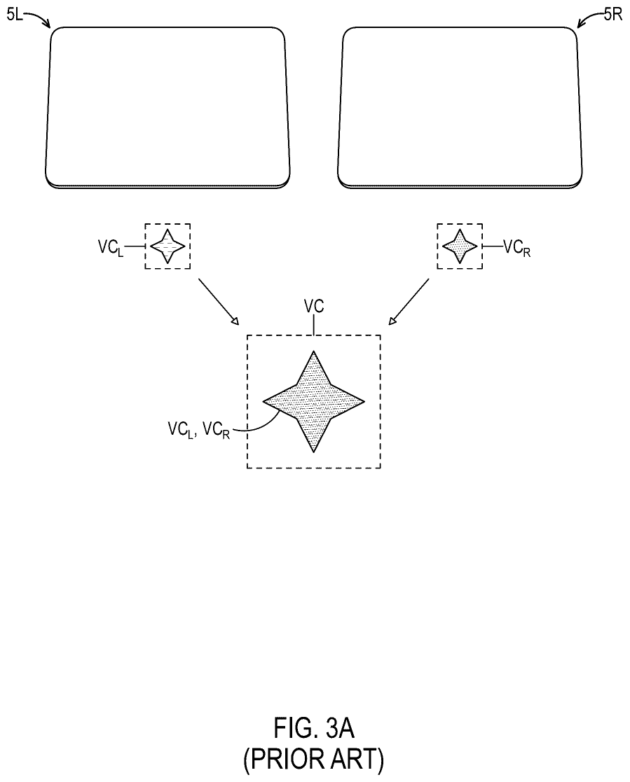

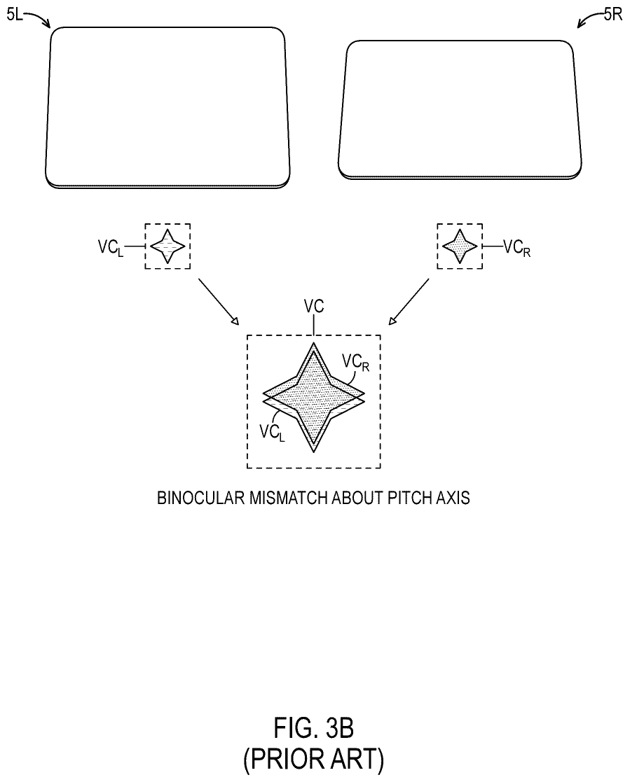

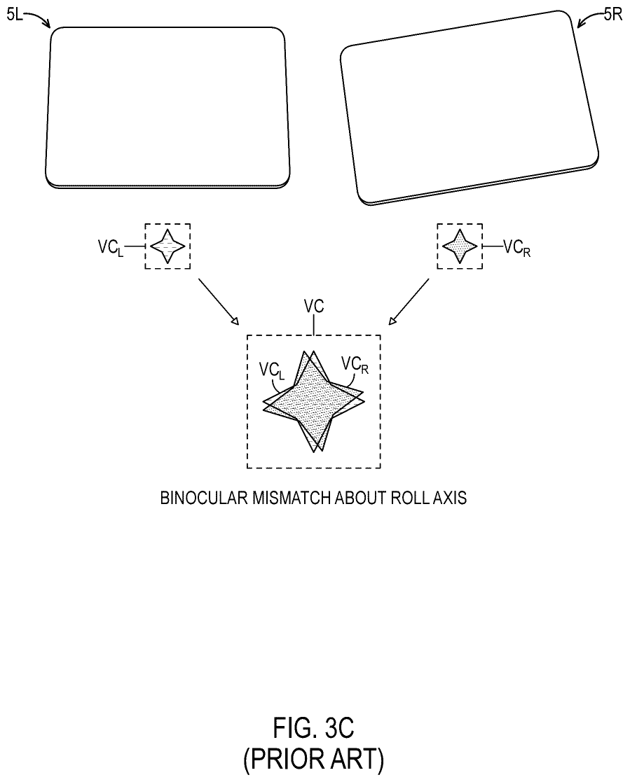

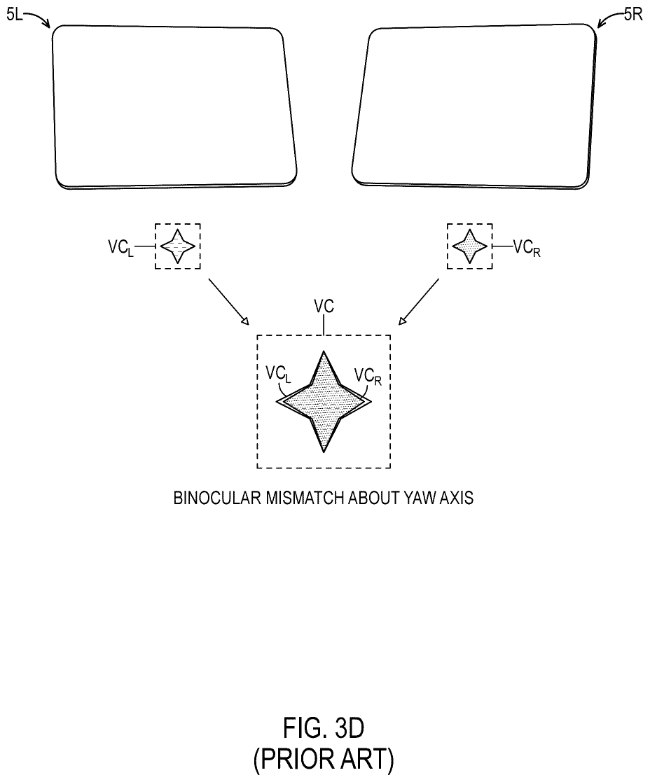

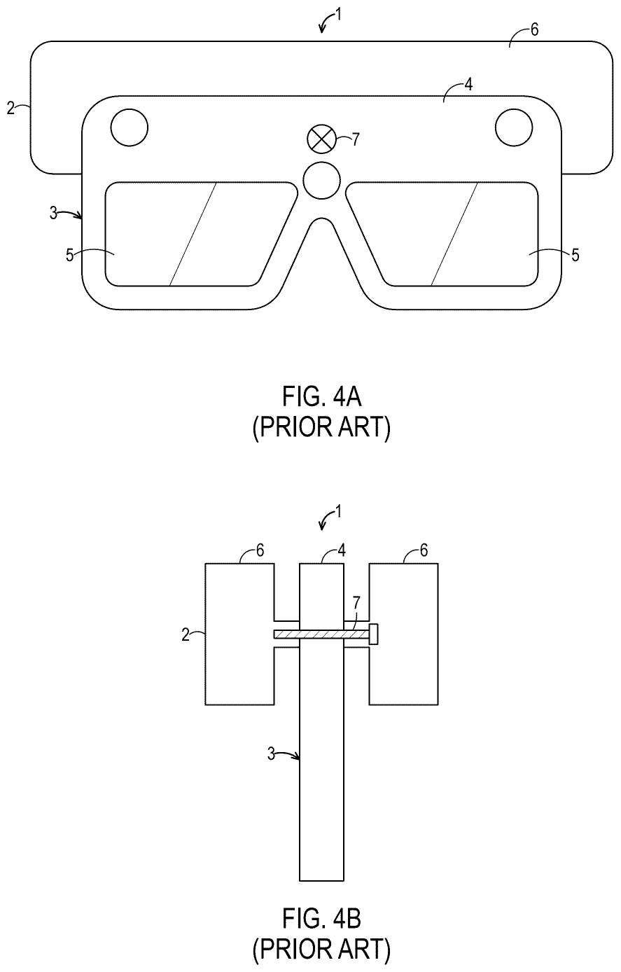

### DETAILED DESCRIPTION

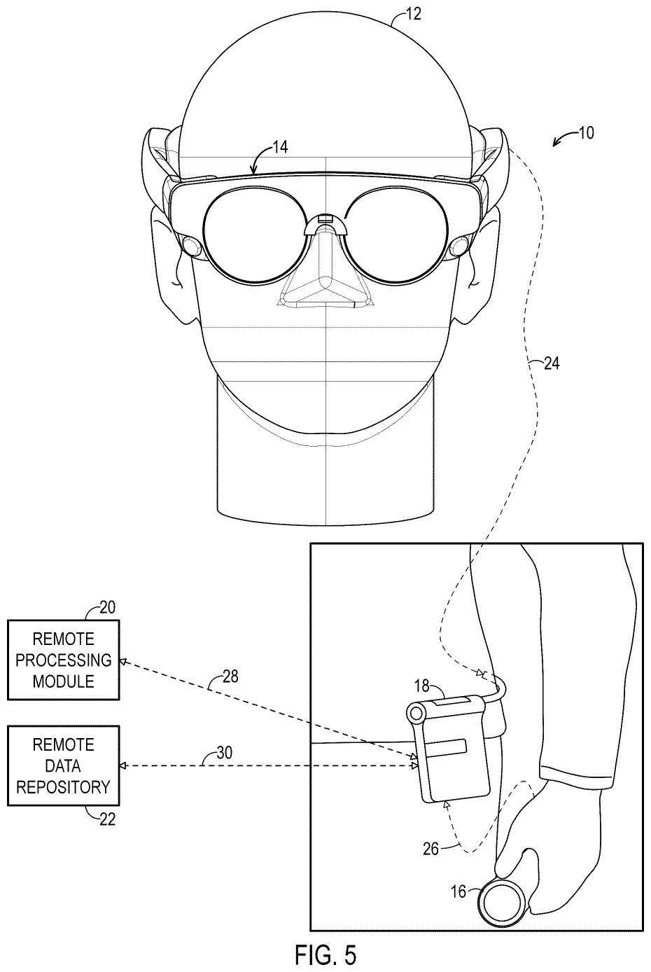

Referring to FIG. 5, an extended reality (XR) system 10 for use by a user 12 generally comprises an eyewear device 14 (e.g., a head-mounted display (HMD)), a hand-held control 16, and a compute pack 18. The HMD 14 is generally configured for presenting virtual content and audio to the user 12, while the hand-held control 16 is configured for enabling the user 12 to interact with the virtual content presented by the HMD 14 to the user 12. The compute pack 18 is configured for being worn by the user 12 remotely from the head of the user 12 (e.g., on the torso of the user in a backpack-style configuration or on the hip of the user in a belt-coupling style configuration). The compute pack 18 may assist the XR system 10 in processing, cashing, and storage of data used to present virtual content to the user. For example, the compute pack 18 may comprise a power-efficient processor or controller, as well as digital memory, such as flash memory, both of which may be utilized to assist in the processing, caching, and storage of data used by the HMD 14 to present virtual content to the user and/or sensor data acquired by the HMD 14. The HMD 14 and and-held control 16 are operably coupled to the compute pack 18 via respective wired or wireless connections 24, 26. The XR system 10 may optionally comprise a remote processing module 20 and remote data repository 22 operatively coupled to the compute pack 18. The remote processing module 20 may comprise one or more relatively powerful processors or controllers configured to analyze and process data and/or image information, while the remote data repository 22 may comprise a relatively large-scale digital data storage facility, which may be available through the internet or other networking configuration in a “cloud” resource configuration. In one embodiment, all data is stored and all computation is performed in the compute pack 18, allowing fully autonomous use from any remote modules. The compute pack 18 may be operably coupled to the remote processing module 20 and remote data repository 22 via wired or wireless connections 28, 30.

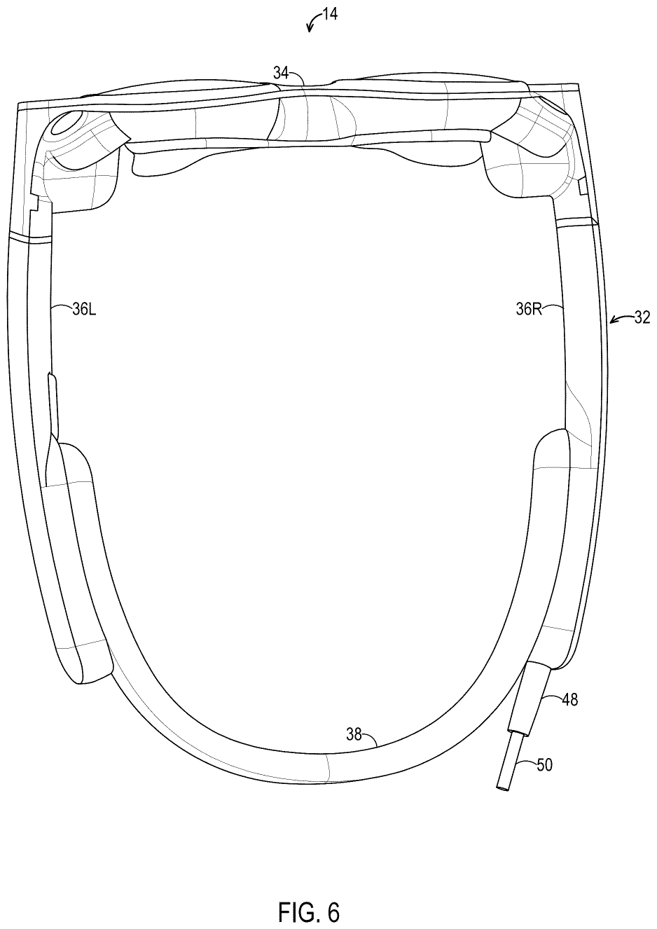

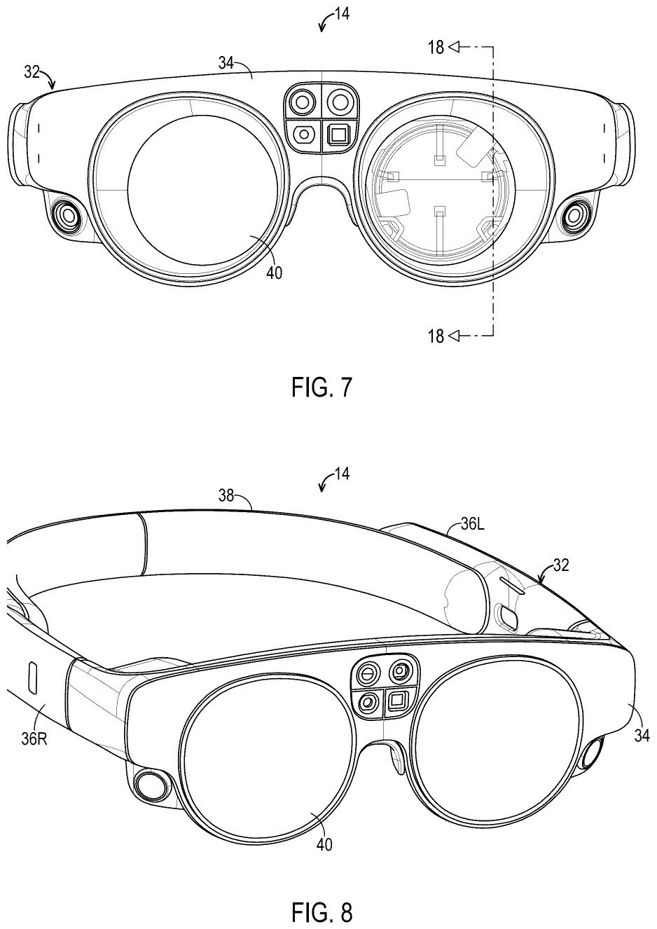

Referring further to FIGS. 6-9, the HMD 14 comprises a frame structure (or housing) 32, which includes a frame front 34, two opposing temple arms 36 (a left temple arm 36L and a right temple arm 36R) affixed to the frame front 34 for allowing the user 12 to comfortably and stably wear the HMD 14, and a torsion band assembly 38 (shown in FIGS. 6 and 8) that connects the opposing temple arms 36L, 36R together and allows the HMD 14 to be adjusted to different head sizes by opening and closing. Further details discussing the torsion band assembly 38 are provided in PCT Application Ser. No. PCT/US22/71109, entitled “Eyewear Device with Improved Stability,” which is expressly incorporated herein by reference.

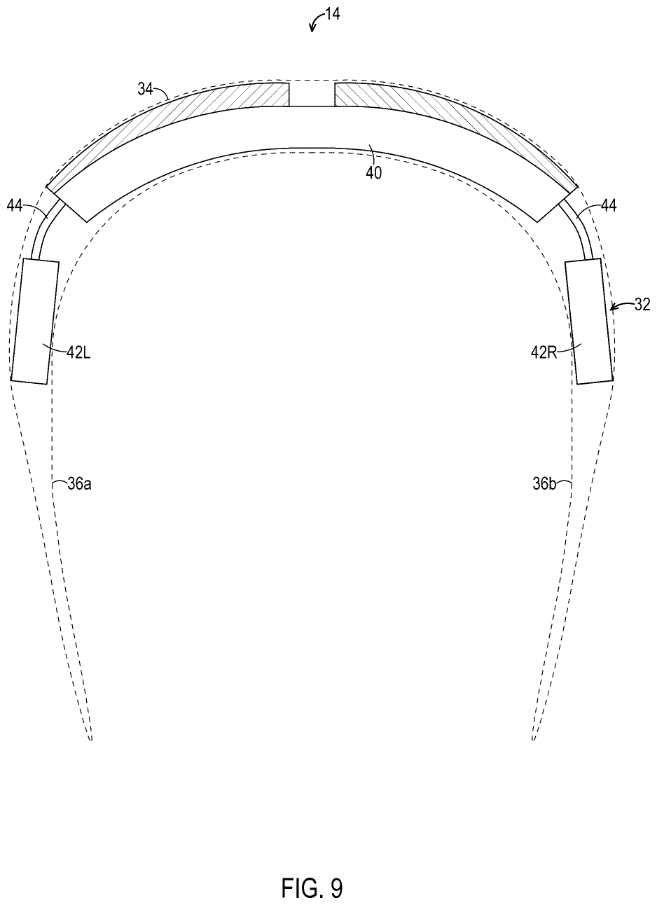

The HMD 14 further comprises an optical assembly in the form of a viewing optics assembly (VOA) 40 (shown best in FIG. 9), which is accommodated in the frame front 34, and a pair of electronics assemblies in the form of printed circuit boards assemblies (PCBAs) 42 (a left PCBA 42L and a right PCBA 42R) (shown in FIG. 9), which are respectively accommodated in the left and right temple arms 36L, 36R. Further details discussing the PCBAs 42 are provided in PCT Application Ser. No. PCT/US22/71109, entitled “Eyewear Device with Improved Stability,” which has previously been expressly incorporated herein by reference. The VOA 40 is positioned in front of the eyes of the user 12 and is configured for projecting light in the form of virtual content into the eyes (i.e., the pupils) of the user 12, as well as optically sensing the environment of the user 12, while the PCBAs 42 are configured for controlling operation of the VOA 40. Further details discussing the VOA 40 and its arrangement with the frame front 34 will be described below. The HMD 14 may also comprise one or more speakers (not shown) affixed to one of the temple arms 36L, 36R adjacent the ear canal of the user 12.

The HMD 14 may further comprise a pair of flex cables 44 (a left flex cable 46L and a right flex cable 46R) that electrically connect the VOA 40 and PCBAs 42 together (e.g., for providing power from the PCBAs 42 to the VOA 40, communicating control signals from the PCBAs 42 to the VOA 40, and/or providing status or sensor signals from the VOA 40 to the PCBAs 42). The HMD 14 may also comprise an electrical connector 46 and associated electrical cable 48 for electrically connecting the PCBAs 42 of the HMD 14 to the compute pack 18, or alternatively to any other portable or stationary computing device, such as a desktop computer, a laptop computer, a smart portable device, etc., that supplies, for example, power and compute resources to the HMD 14.

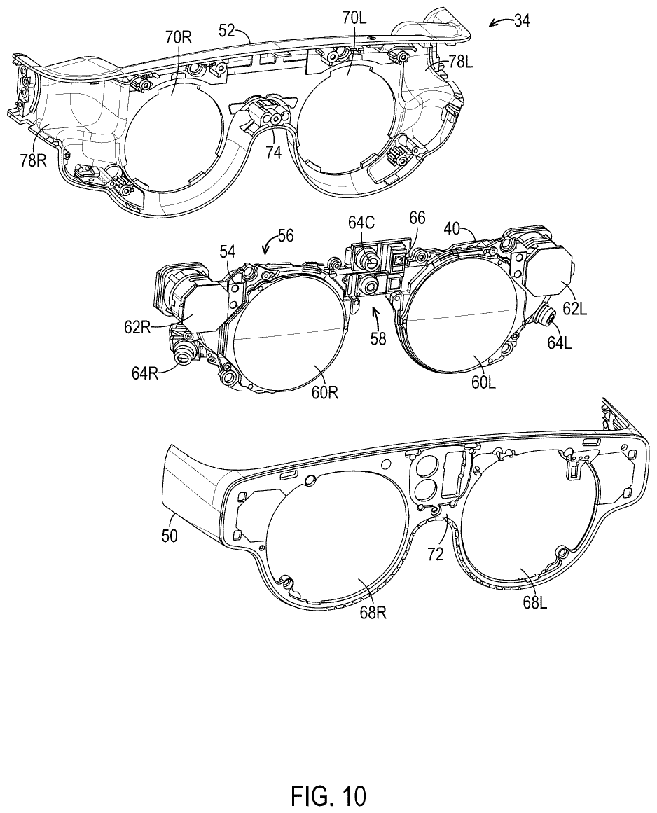

Referring now to FIG. 10, the frame front 34 of the frame structure 32 comprises a front housing portion 50 and a rear housing portion 52 that are suitably affixed to each other to support the VOA 40 therein. The VOA 40 generally comprises a chassis 54 and a plurality of optical components affixed to the chassis 54. In the illustrated embodiment, the plurality of optical components may be arranged as an optical display assembly 56 and an optical sensor assembly 58.

The optical display assembly 56 is designed to present the eyes of the user 12 with photo-based radiation patterns in the form of a high frequency sequence of frames that can be comfortably perceived as a single coherent scene with high-levels of image quality and three-dimensional perception. To this end, the optical display assembly 56 may comprise a display 60 (and in particular, a left eyepiece 60L and a right eyepiece 60R) and a light projector assembly 62 (and in particular, a left light projector 62L and a right light projector 62R).

If the XR system 10 takes the form of an AR or MR system, the optical display assembly 56 presents virtual content to the user that will appear as an augmentation to physical reality. In this case, the display 60 employs an “optical see-through” display through which the user 12 can directly view light from real objects in the ambient environment. Thus, the display 60 (i.e., the left and right eyepieces 60L, 60R) may be either transparent (or semi-transparent) and serves as a combiner that superimposes light representing the virtual content over the user's 12 view of the real world. The frame structure 32 is designed to carry the two transparent eyepieces 60L, 60R in a manner that positions the eyepieces 60L, 60R respectively in front of the eyes of the end user 12 for presentation of monocular images to the user 12 as a binocular image, as well as positions the eyepieces 60L, 60R in the user's 12 field of view between the eyes of the user 12 and the ambient environment, such that direct light from the ambient environment is transmitted through the eyepieces 60L, 60R respectively to the eyes of the end user 12. In an alternative embodiment, video of the real world acquired by optical sensor assembly 58 (described in further detail below) may be intermixed with the virtual content (e.g., using a video processor (not shown) located in the compute pack 18) and then presented by the optical display assembly 56 onto the display 60. In this case, the left and right eyepieces 60L, 60R may be opaque. In the case where the XR system 10 takes the form of a VR system, the left and right eyepieces 60L, 60R may be opaque without any direct or indirect view of the real world.

The optical sensor assembly 58 comprises one or more outward facing world-view cameras 64 (or field of view (FOV) cameras), and in particular a left world-view camera 64L affixed to the left periphery of the chassis 54, a center world-view camera 64C affixed to the center of the chassis 54 between the eyepieces 60L, 60R, and a right world-view camera 64R affixed to the right periphery of the chassis 54, and one or more inward facing eye-tracking cameras (not shown), and in particular a left eye-tracking camera for tracking the left eye, and a right eye-tracking camera for tracking the right eye. The world-view cameras 64 record a greater-than-peripheral view to map the real-world environment and detect inputs that may affect augmented reality content. For example, the images captured by the world-view cameras 64 may be added to a world model by including new pictures that convey information about various points and features of the real world, which world model can be passable to other uses, or the images captured by the world view cameras 64 may be used to recognize objects in the real world. The field of view of the cameras 64 may be greater than the field of view of the user 12 (e.g., 190 degrees). The eye-tracking cameras detect metrics of the eyes of the user 12, such as eye shape, eyelid occlusion, and pupil direction and glint. The VOA 40 may also comprise one or more depth sensors 66, and in particular, a single depth sensor 66 affixed to the center of the chassis 54 between the eyepieces 60L, 60R. The depth sensor 66, such as a time-of-flight sensor, emits relay signals to the world to determine distance to given objects and/or to determine whether objects have entered the field of view of the user 12, either as a result of motion of those objects or a change of pose of the user 12. In some embodiments, the depth sensor 66 may not relay on time-of-flight information, but rather may take the form of a plenoptic camera, whose pixels may capture light intensity and an angle of the incoming light, from which depth information can be determined. For example, a plenoptic camera may include an image sensor overlaid with a transmissive diffraction mask (TDM). Alternatively or additionally, a plenoptic camera may include an image sensor containing angle-sensitive pixels and/or phase-detection auto-focus pixels (PDAF) and/or micro-lens array (MLA). The VOA 40 may include other sensors that may be adversely affect by mechanical distortion of the VOA 40, e.g., inertial measurement units (IMUs), global positioning systems (GPSs), radio devices, accelerometers, gyroscopes, etc., affixed to the chassis 54.

The front and rear housing portions 50, 52 respectively include eye cutouts 68, 70 for providing a line of sight between the eyes of the user 12 and the outside environment via the eyepieces 60 of the VOA 40. In particular, the front and rear housing portions 50, 52 include left eye cutouts 68L, 70L for providing a line of sight between the left eye of the user 12 and the outside environment via the eyepiece 60L of the VOA 40, and include right eye cutouts 68R, 70R for providing a line of sight between the right eye of the user 12 and the outside environment via the eyepiece 60R of the VOA 40. The front and rear housing portions 50, 52 also respectively include nose bridge portions 72, 74 for accommodating the nose of the user 12. The front housing portion 50 further comprises cutouts 76 located on the bridge portion 72 through which some components (e.g., the center world-view camera 64C and depth sensor 66) of the VOA 40 may extend for providing their sensor functions. The rear housing portion 52 further comprises left and right cavities 78L, 78R for respectively accommodating the left and right projection assemblies 62L, 62R.

Referring to FIG. 11, the details of one monocle (the left or the right monocle) of the VOA 40 for one eye of the user 12 will be described. The entire VOA 40 may include two such monocles, one for each eye of the user 12. One monocle includes the combination of the left eyepiece 60L and left projector 62L or the combination of the right eyepiece 60R and right projector 62R.

Each light projector 62 provides scanned light respectively to the eyepiece 60. For example, each light projectors 62L may include light sources 80 in the form of groups of light emitting diodes (LEDs) (e.g., a group of red LEDs, a group of green LEDs, and a group of blue LEDs. Each light projector 62 may also comprise a collimator 82 that collimates light from the light sources 80, a projector lens assembly 84 for focusing the collimating light of the collimator 82, and a spatial light modulator (“SLM”) 86, such as a liquid crystal on silicon (“LCOS”) component, for encoding the image light with virtual content.

Each eyepiece 60 may take the form of a waveguide-based display, each having three layers into which the red light, green light, and blue light from the light projector 62 is injected. Each eyepiece 60 may also have multiple layers to produce, e.g., virtual images at a single optical viewing distance closer than infinity (e.g., arm's length), images at multiple, discrete optical viewing distances or focal planes, and/or image layers stacked at multiple viewing distances or focal planes to represent volumetric 3D objects. For example, each eyepiece 60 may have six layers, i.e., one set of three layers for each of the three colors for forming a virtual image at one depth plane, and another set of three layers for each of the three colors for forming a virtual image at another depth plane. These layers in the light field may be stacked closely enough together to appear continuous to the human visual subsystem (i.e., one layer is within the cone of confusion of an adjacent layer). Additionally or alternatively, picture elements may be blended across two or more layers to increase perceived continuity of transition between layers in the light field, even if those layers are more sparsely stacked (i.e., one layer is outside the cone of confusion of an adjacent layer).

Each layer of an eyepiece 60 takes the form of a waveguide apparatus comprising a planar optical waveguide 88 that is generally parallel to the field of view of the user 12, an in-coupling grating (ICG) 90 affixed to the surface of the planar optical waveguide 88 facing the respective light projector 62, an orthogonal pupil expander (OPE) region 92 affixed to the planar optical waveguide 88, and an exit pupil expander (EPE) region 94 affixed to the surface of the planar optical waveguide 88 facing the respective eye 96 of the user 12. The light projector 62 projects image light onto the ICG 90 in a layer (i.e., a planar optical waveguide 88) of the respective eyepiece 60. The ICG 90 couples the image light from the projector lens 84 into the planar optical waveguide 88 propagating in a direction toward the OPE region 92. The planar optical waveguide 84 propagates the image light in the horizontal direction by total internal reflection (TIR). The OPE region 92 includes a diffractive element that couples and redirects a portion of the image light propagating in the planar optical waveguide 88 toward the EPE region 94. The EPE region 94 includes a diffractive element that couples and diverts a portion of the image light propagating in the planar optical waveguide 88 in a direction approximately perpendicular to the plane of the planar optical waveguide 88 towards the eye 96 of the user 12. In this manner, an image projected by the light projector 62 may be viewed by the eye of the user 12.

Further details of the VOA 40 are described in U.S. Patent Publication Nos. 2021/0109287 and 2022/0148538, which are expressly incorporated herein by reference.

Despite the rigidity of the frame front 34 and VOA 40, static distortion loads applied to the frame front 34 may potentially be mechanically communicated to the VOA 40, thereby causing the chassis 54 of the VOA 40 to exhibit monocular and/or binocular deformation, ultimately resulting in the relative translation and/or rotation of the optical components (such as, e.g., the eyepieces 60L, 60R, projection assemblies 62L, 62R, world-view cameras 64L, 64C, 64R) affixed to the chassis 54. Static deformation loads can be consider small magnitude deformation loads that are directly or indirectly applied to the frame front 34 during handling of the frame structure 32 (either or both of the temple arms 36 and/or the frame front 34 directly) or quick movements of the head of the user 12 that deforms the frame front 34 on a long time scale, whereas dynamic deformation loads can be considered large magnitude deformation loads that are directly or indirectly applied to the frame front 34 during a drop or impact event.

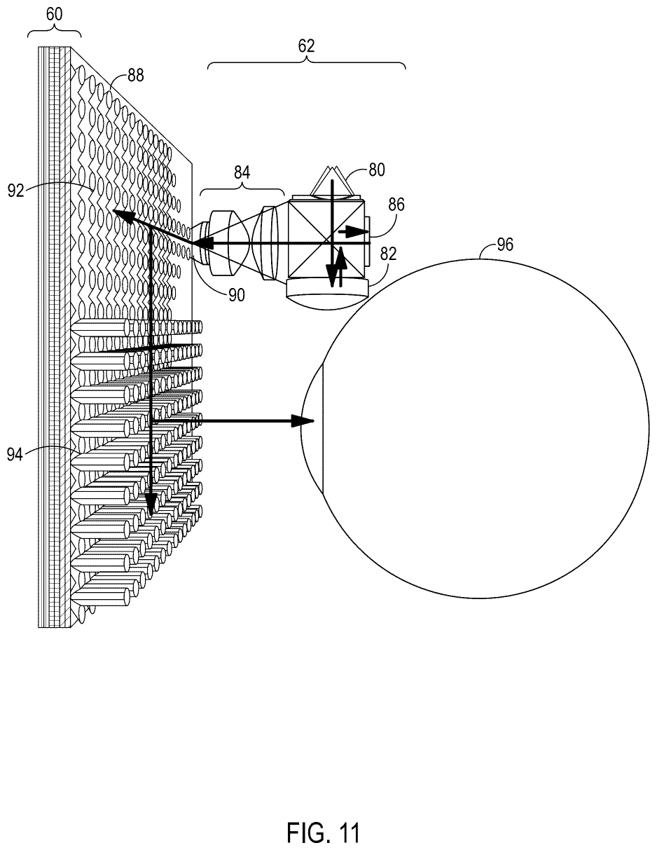

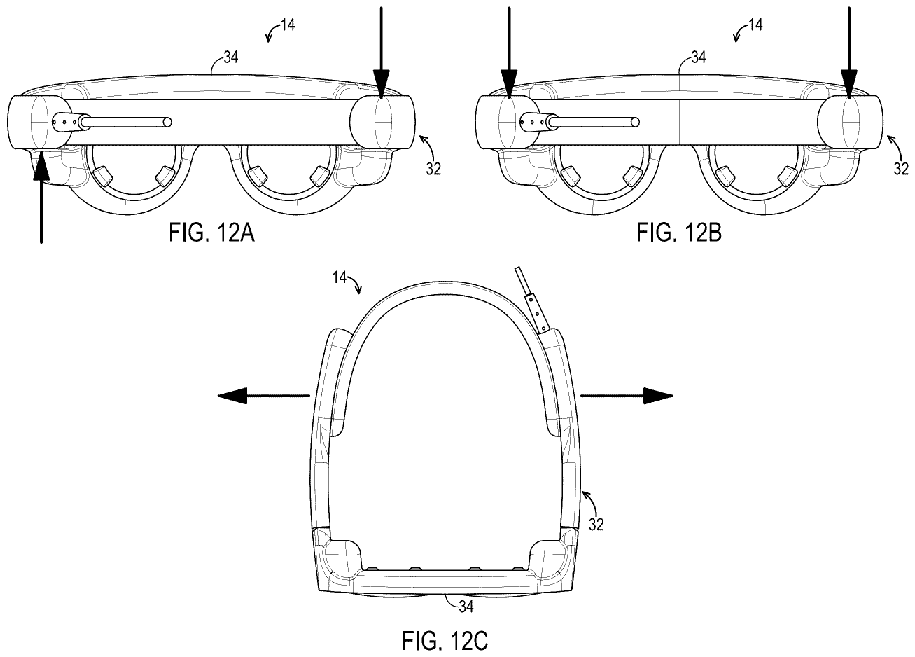

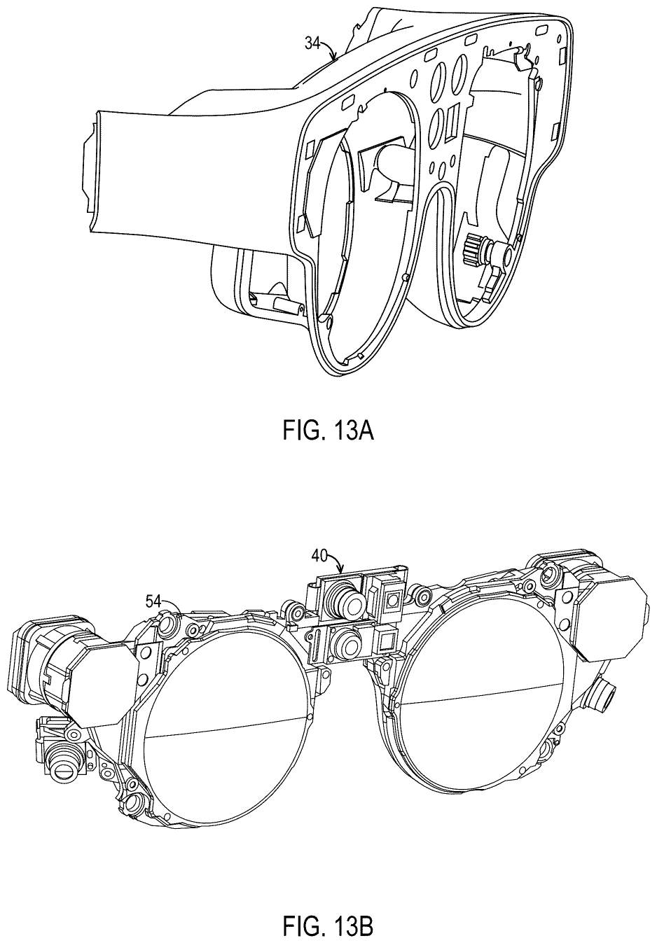

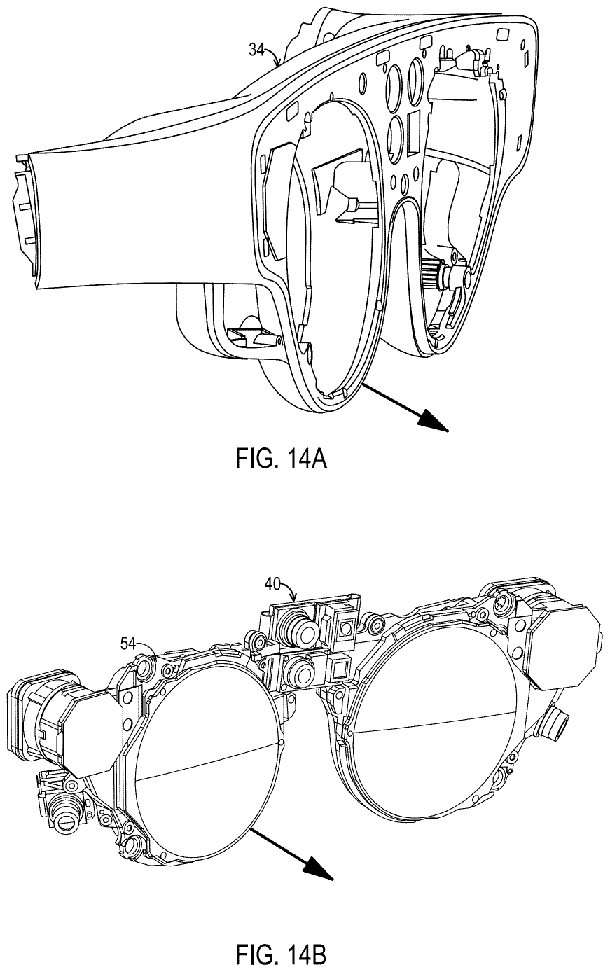

The application of a static deformation load to the frame front 34 may, e.g., a twist load (FIG. 12A), a vertical pull load (FIG. 12B), or a temple spread load (FIG. 12C). As a result, if the VOA 40 were to be rigidly mounted to the frame front 34 at multiple points, transformation of the frame front 34 from a nominal undeformed state (FIG. 13A) to a deformed state (FIG. 14A) will likewise cause the VOA 40 to transform from a nominal undeformed state (FIG. 13B) to a deformed state (FIG. 14B) that translates and/or rotates the optical components of the VOA 40 relative to each other. Significantly, however, the VOA 40 is not rigidly mounted to the frame front 34, but rather “floats” with respect to the frame front 34 (and/or the housing 32 as a whole), such that a static deformation load applied to the frame front 34 is not substantially mechanically communicated to the VOA 40, and thus, the VOA 40 maintains its undeformed state.

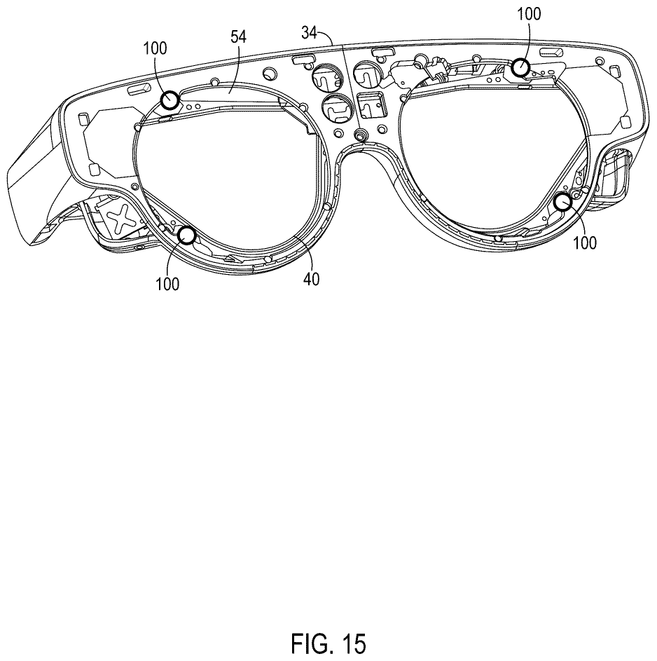

In particular, with reference to FIG. 15, the eyewear HDM 14 further comprises a plurality of flexible mounts 100 mechanically coupling the chassis 54 of the VOA 40 to the frame front 34. In the illustrated embodiment, the flexible mounts 100 mechanically couple the outer periphery of the chassis 54 of the VOA 40 to the frame front 34, although the flexible mounts 100 may mechanically couple any portion (including an inner portion) of the chassis 54 of the VOA 40 to the frame front 34. In the illustrated embodiment, the number of flexible mounts 100 equals four, although any plurality number of flexible mounts 100 may be used, including two, three, or more than four.

Each of the flexible mounts 100 has a rigidity that is less than both the frame front 34 and the rigidity of the chassis 54. In particular, the frame front 34 has a relatively high rigidity in all directions to at least provide a minimal amount of resistance to deformation in response to the application of external loads. To this end, the frame front 34 is composed of a material having a relatively high modulus of elasticity (Young's modulus), such as, e.g., magnesium, aluminum, carbon fiber composite, steel, etc. The chassis 54 likewise has a relatively high rigidity, and in particular, a relatively high planar rigidity (i.e., the strength to resist deformation in response to a force perpendicular to the plane of the chassis 54), and a relatively high lateral rigidity (i.e., the strength to resist deformation in response to a force parallel to the plane of the chassis 54). It should be appreciated that, although it is preferred that both the planar rigidity and lateral rigidity of the chassis 54 be substantially uniform throughout the chassis 54, such planar rigidity and lateral rigidity of the chassis 54 may vary, such that the chassis 54 has a minimum planar rigidity and a minimum lateral rigidity at weak points. To this end, the chassis 54 is composed of a material having a relatively high modulus of elasticity (Young's modulus), such as, e.g., magnesium, aluminum, carbon fiber composite, steel, etc., such that the chassis 54 has the necessary rigidity to maintain the relative locations of the optical components affixed to the chassis 54 in the presence of the application of minimal forces (e.g., the force of gravity) to the VOA 40.

Likewise, although chassis 54, due to its relatively high rigidity, resists deformation in response to an application of a static deformation load to the chassis 54, a certain static deformation load applied to the chassis 54, may, in theory, surpass a threshold that substantially deforms the chassis 54, as illustrated in FIG. 14B, resulting in movement of the optical components relative to each other to the extent that performance of the optical components deviate from their intended or as-designed position(s) or even fall outside a permissible range, such that the performance and/or user experience of the eyewear device is hindered. Such deformation load threshold may be exceeded if the VOA 40 is rigidly mounted within the frame front 34 at multiple points. That is, in such a case, almost all of the static deformation load applied to the frame front 34 would be mechanically communicated to the VOA 40. Thus, the chassis 54 may substantially deform in response to the application of a static deformation load to the frame front 34 that exceeds the static deformation load threshold of the VOA 40, as illustrated in FIG. 14B.

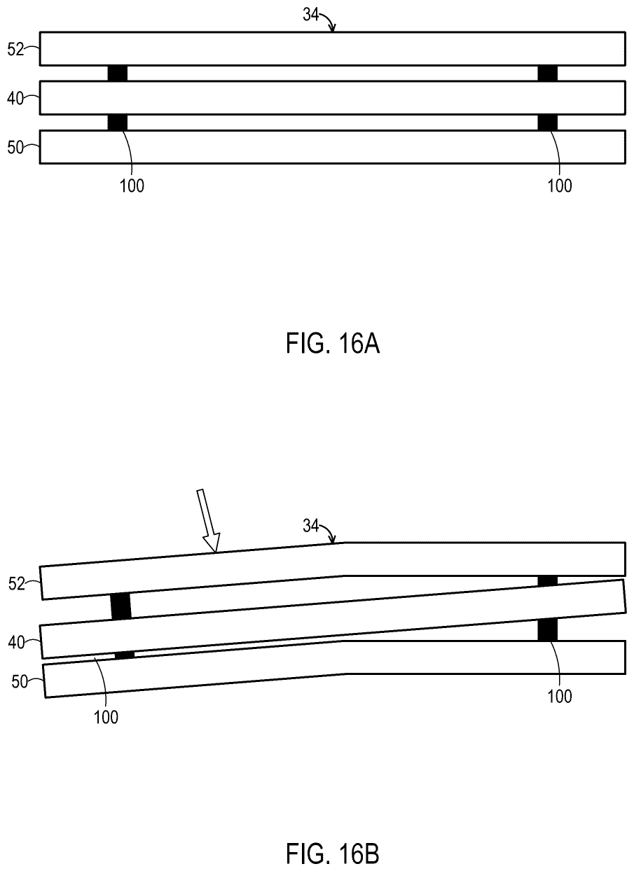

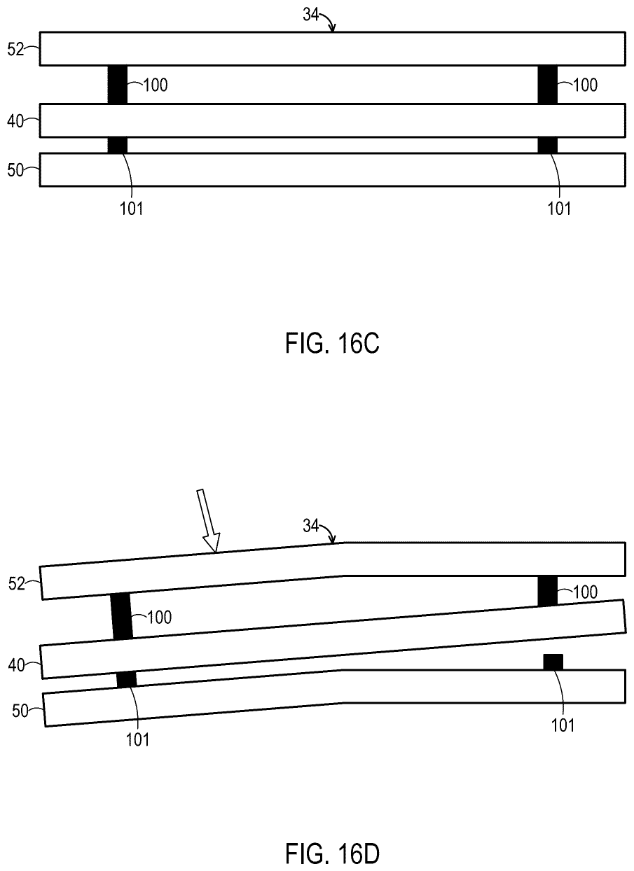

However, the flexible mounts 100 are designed to allow the VOA 40 to move relative to the frame front 34, serving, in a sense, as springs that absorb energy in response to the application of the static deformation load to the frame front 34. That is, the flexible mounts 100 filter out the static deformation load applied to the frame front 34, such that none or only a small amount of the static deformation load is communicated to the VOA 40. Thus, the flexible mounts 100 are configured for maintaining the VOA 40 at a nominal position relative to the frame front 34 in the absence of the application of the static deformation load to the frame front 34 (as illustrated in FIG. 16A), preventing at least a portion of the static deformation load applied to the frame front 34 from being mechanically communicated to the VOA 40, such that the entire VOA 40 translates (linearly and/or rotationally) from the nominal position to a new position relative to the frame front 34 in response to the application of the static deformation load to the frame front 34 (as illustrated in FIG. 16B), and allowing the entire VOA 40 to translate from the new position back to the nominal position (or perhaps a third position) relative to the frame front 34 in response to a cessation of the application of the static deformation load to the frame front 34 (as illustrated in FIG. 16A). As shown in FIG. 16B, rather than the VOA substantially deforming, the flexible mounts 100 substantially deform when absorbing the energy of the static deformation load that is applied to the frame front 34.

So that the flexible mounts 100 deform to absorb the energy of the applied static deformation lead, each of the flexible mounts 100 has a relatively low rigidity (i.e., less than the rigidities of the frame front 34 and chassis 54 of the VOA 40) in at least one direction, such that the flexible mount 100 easily deforms in response to at least one force respectively parallel to the direction(s) of rigidity. For example, each of the flexible mounts 100 may have a relatively low rigidity in a direction perpendicular to the plane of the chassis 54, such that the flexible mount 100 easily deforms in response to a force perpendicular to the plane of the chassis 54 (thereby preventing at least a portion of the static deformation load applied to the frame front 34 from being mechanically communicated in a direction perpendicular to the VOA 40), and a relatively low rigidity in a direction parallel to the plane of the chassis 54, such that the flexible mount 100 easily deforms in response a force parallel to the plane of the chassis 54 (thereby preventing at least a portion of the static deformation load applied to the frame front 34 from being mechanically communicated along a direction parallel to the VOA 40). To this end, each of the flexible mounts 100 is at least partially composed of a material having a relatively low modulus of elasticity (Young's modulus), such as, an elastomeric material, e.g., rubber, neoprene, silicone, nitrile, polyurethane, etc. Preferably, at the least, the portion of each of the flexible mounts 100 that comes in contact with the chassis 54 is composed of such elastomeric material. Due to their relatively low rigidity, the flexible mounts 100 are configured for preventing at least a portion (e.g., less than fifty percent, and preferably less than seventy-five percent) of a static deformation load applied to the frame front 34 (which distorts the frame front 34) from being mechanically communicated to the VOA 40. This allows the entire VOA 40 to translate (linearly or rotationally) relative to the distorted frame front 34 without distortion (i.e., the VOA 40 essentially floats relative to the frame front 34). Thus, in this case, the chassis 54 will not substantially deform in response to the application of a static deformation load to the frame front 34 that exceeds the static deformation load threshold of the VOA 40.

Although each of the flexible mounts 100 has been described as being flexible in that each mount 100 has a relatively low rigidity, it should be appreciated that some of the flexible mounts 100 may have a relatively high rigidity (e.g., the same as, or greater rigidity than, the frame front 34 and/or chassis 54 of the VOA 40), such that less than all of the flexible mounts 100 have a relatively low rigidity. However, it is generally desirable that as many of the flexible mounts 100 as possible with relatively low rigidities be used in order to avoid an overstrained case where the VOA 40 may not translate relative to the frame front 34 in response to the application of a static deformation load on the frame front 34, and thus, may distort. Furthermore, although it is desirable that the relatively low rigidities of the flexible mounts 100 be uniform, it should be appreciated that the rigidities of the flexible mounts 100 may vary relative to each other; that is, all of the flexible mounts 100 may have relatively low rigidities, but with different magnitudes.

Although the flexible mounts 100 are illustrated in FIG. 16A as maintaining the VOA 40 at a nominal position in the absence of the application of the static deformation load to the frame front 34 that is equi-distant between the housing portions 50, 52 of the frame front 34, in alternative embodiments, flexible mounts may bias the VOA 40 towards one of the housing portions 50, 52 of the frame front 34, such that the VOA 40 is maintained at a nominal position in the absence of the application of the static deformation load to the frame front 34 that is not equi-distant between the housing portions 50, 52 of the frame front 34. For example, the flexible mounts 100 may be located only on one side of the VOA (in this case, between the VOA 40 and the front housing portion 50 of the frame front 34), such that the VOA 40 is biased, pushed, or buoyed away from the front housing portion 50 and towards the rear housing portion 52 of the frame front 34. Thus, in this case, the flexible mounts 100 maintain the VOA 40 at a nominal position in the absence of the application of the static deformation load to the frame front 34 that is closer to the rear housing portion 52 than the front housing 50 of the frame front 34 (as illustrated in FIG. 16C).

Rigid stops 101 may be located on the opposite side of the VOA 40 (in this case, affixed to the rear housing portion 52 of the frame front 34 to prevent the VOA 40 from contacting the rear housing portion 52 in response to the application of the static deformation load to the frame front 34 (as illustrated in FIG. 16D). The flexible mounts 100 allow the entire VOA 40 to translate from the new position back to the nominal position relative to the frame front 34 in response to a cessation of the application of the static deformation load to the frame front 34 (as illustrated in FIG. 16C). Notably, the VOA 40 bears against the rigid stops 101 when the VOA 40 is at a nominal position in the absence of the application of the static deformation load to the frame front 34, such that the flexible mounts 100 are maintained in a constant state of compression that ensures that the VOA 40 returns from the new position back to the nominal position.

Although the flexible mounts 100 are described and illustrated as being located between the VOA 40 and the front housing portion 50 of the frame front 34, while the rigid stops 101 are located between the VOA 40 and the rear housing portion 52 of the frame front 34, such that the VOA 40 is biased away from the front housing portion 50 toward the rear housing portion 52, it should be appreciated that the flexible mounts may be located between the VOA 40 and the rear housing portion 52 of the frame front 34, while the rigid stops 101 may be located between the VOA 40 and the front housing portion 50, such that the VOA 40 is biased away from the rear housing portion 52 towards the front housing portion 50.

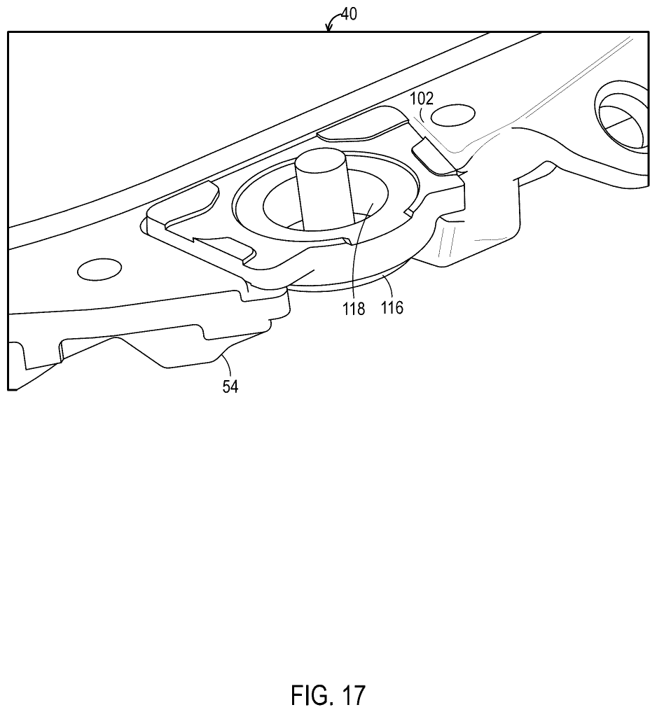

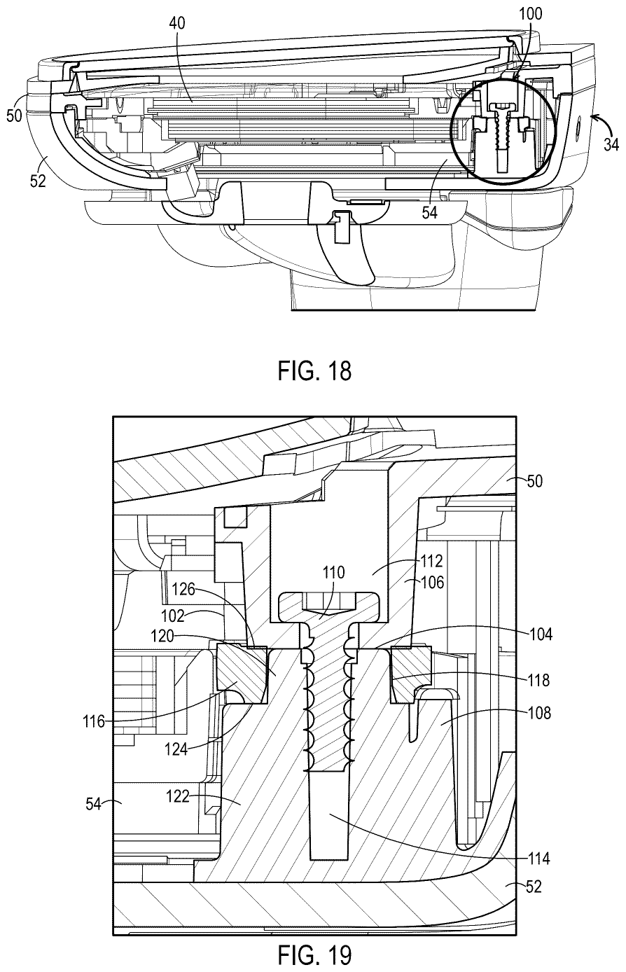

In one particularly advantageous embodiment illustrated in FIGS. 17-20, the chassis 54 comprises a plurality of apertures 102 (in this case, through-holes) (only one shown in FIGS. 17-20), and each of the flexible mounts 100 comprises a rigid boss 104 extending from the frame front 34 through a respective one of the through-holes 102 on the chassis 54. In the illustrated embodiment, each of the rigid bosses 104 has a boss component 106 extending from the front housing portion 50 and a boss component 108 extending from the rear housing portion 52. The boss components 106, 108 may be composed of the same material as, and may be formed as a unibody structure with, the housing portions 50, 52. Each of the flexible mounts 100 further comprises a fastener 110 (e.g., a screw) that affixes the respective boss components 106, 108 together, thereby affixing the housing portions 50, 52 to each other. For example, the boss component 106 extending from the front housing portion 50 may include a recessed cavity 112 in which the head of the fastener 110 may be retained, while the boss component 108 extending from the rear housing portion 50 may include a threaded bore 114 in which the threaded shaft of the fastener 110 may be screwed. As will be described in further detail below, the frame front 34 may include additional mounting regions (e.g., around the bridge portions 72, 74 of the respective front and rear housing portions 50, 52 for affixing the housing portions 50, 52 together.

Significantly, each of the flexible mounts 100 further comprises a compliant bushing 116 (which may be composed of a suitable elastomeric material, e.g., e.g., neoprene, silicone, nitrile, polyurethane, etc.) affixed around the respective relatively rigid boss 104; e.g., around the boss component 108 extending from the rear housing portion 52. In particular, the compliant bushing 116 has a through-hole 118 through which the relatively rigid boss 104 stably extends. The compliant bushing 116 is seated within the respective through-hole 102 of the chassis 54, such that the through-hole 102 of the chassis 54, the compliant bushing 116, and the relatively rigid boss 104 are in a coaxial arrangement, with the compliant bushing 116 being disposed between the chassis 54 and the relatively rigid boss 104. The chassis 54 is affixed to the compliant bushing 116 (in this case, to the outer periphery of the compliant bushing 116), such that no portion of the VOA 40 comes in contact with the frame front 34. The compliant bushing 116 is disposed around the reduced diameter portion 120 of the boss component 108 and retained between the annular ledges 124, 126. The compliant bushing 116 is affixed around an axial location of the relatively rigid boss 104, such that the chassis 54 is located a nominal distance from the frame front 34, preferably in all of the x-, y-, and z-directions (i.e., along the x-y plane of the chassis 54 and the z-axis perpendicular to the plane of the chassis 54). In this manner, any mechanical conduction path that communicates the static deformation load applied to the frame front 34 to the chassis 54 can be avoided. Instead, substantially all of static deformation load applied to the frame front 34 will be absorbed by the compliant bushings 108 of the flexible mounts 100. As best illustrated in FIG. 19, the boss component 108 extending from the rear housing portion 52 comprises a reduced diameter portion 120, and a normal diameter portion 122 that forms an annular ledge 124 with the reduced diameter portion 120. The diameter of the boss component 108 extending from the front housing portion 50 is greater than the diameter of the reduced diameter portion 120, thereby forming another annular ledge 126 therebetween.

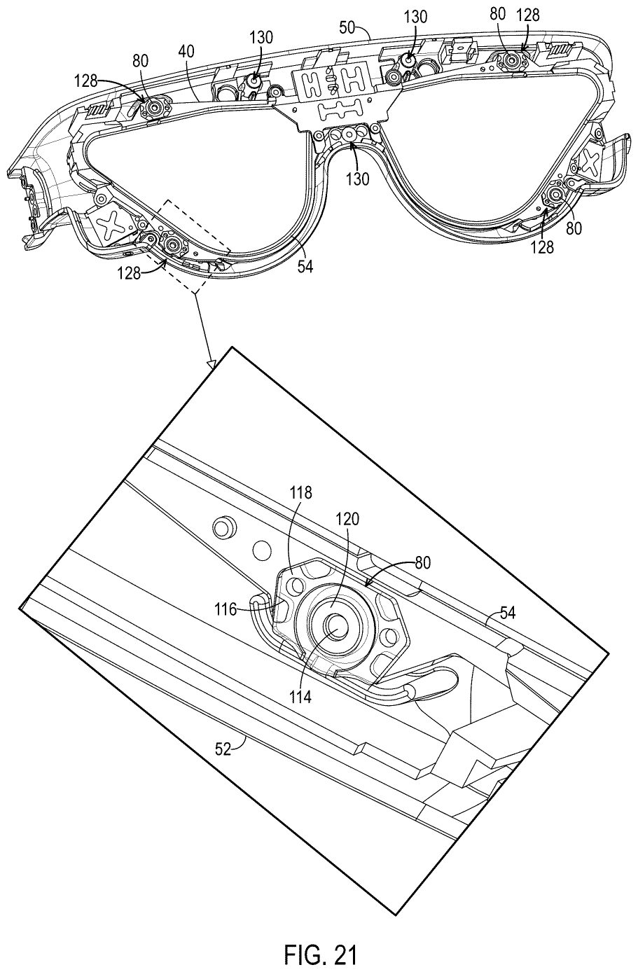

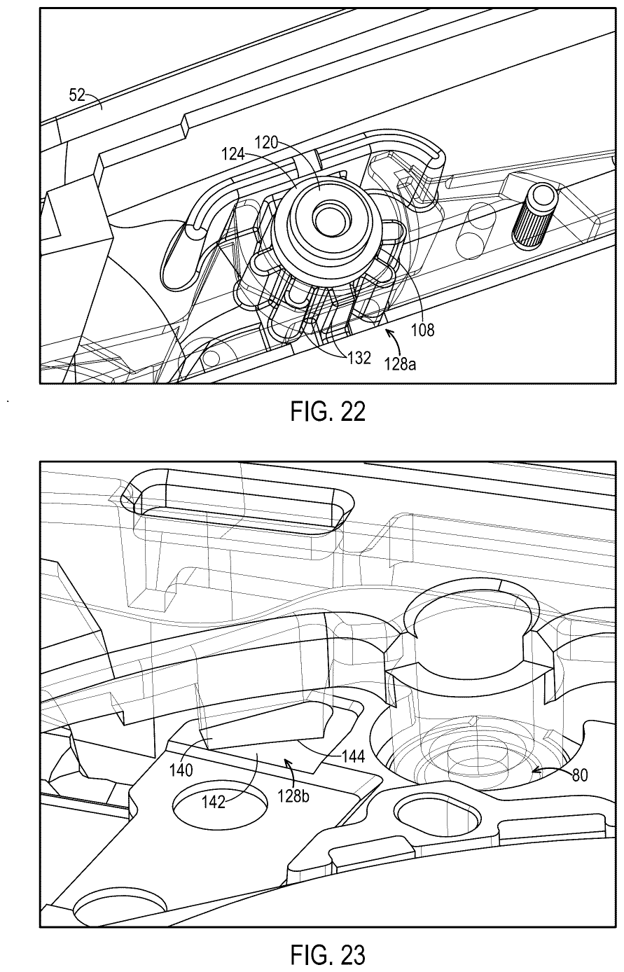

Referring further to FIGS. 21-24, the HMD 14 further comprises a plurality of rigid stop assemblies, and in this case, four rigid stop assemblies 128 respectively adjacent the four flexible mounts 100 around the periphery of the chassis 54 of the VOA 40, and three rigid stop assemblies 130 adjacent the nose bridge portions 72, 74 of the front and rear housing portions 50, 52. The rigid stop assemblies 128, 130 limit the relative motion between the VOA 40 and the frame front 34 in order minimize permanent deformation of the VOA 40 during dynamic deformation (impact events) by controlling where the energy is imparted to the VOA 40 in response to the application of a dynamic load to the frame front 34 and directing the dynamic loads into the chassis 54 at strategic locations (hard stop locations) where the VOA 40 is the strongest. In particular, the rigid stop assemblies 128, 130 are configured for creating a plurality of contact points in response to a dynamic deformation load applied to the frame front 34, such that at least a portion of the dynamic deformation load applied to the frame front 34 is communicated to the chassis 54 of the VOA 40 through the contact points. In the illustrated embodiment, each of the rigid stop assemblies 128, 130 is configured for communicating a portion of the dynamic deformation load applied to the frame front 34 in both a direction perpendicular to, and a direction parallel with, the plane of the chassis 54 of the VOA 40. To strategically create the control points, clearance gaps are provided between these strategic VOA locations and the frame front 34 that smaller than any gaps between the sensitive regions of the VOA 40 and the frame front 34, thereby avoiding collisions of the sensitive regions of the VOA 40 with the frame front 34. That is, in response to the application of a dynamic load to the frame front 34, the strategic locations of the VOA 40 will contact the frame front 34 first, such that the sensitive regions of the VOA 40 do not come in contact with the frame front 34 In the illustrated embodiment, each of the rigid stop assemblies 128 comprises an x-y stop 128a (best shown in FIG. 22) configured for communicating the dynamic deformation load applied to the frame front 34 in a direction parallel with the plane of the chassis 54, and a z stop 128b (best shown in FIG. 23) configured for communicating the dynamic deformation load applied to the frame front 34 in a direction perpendicular to the plane of the chassis 54.

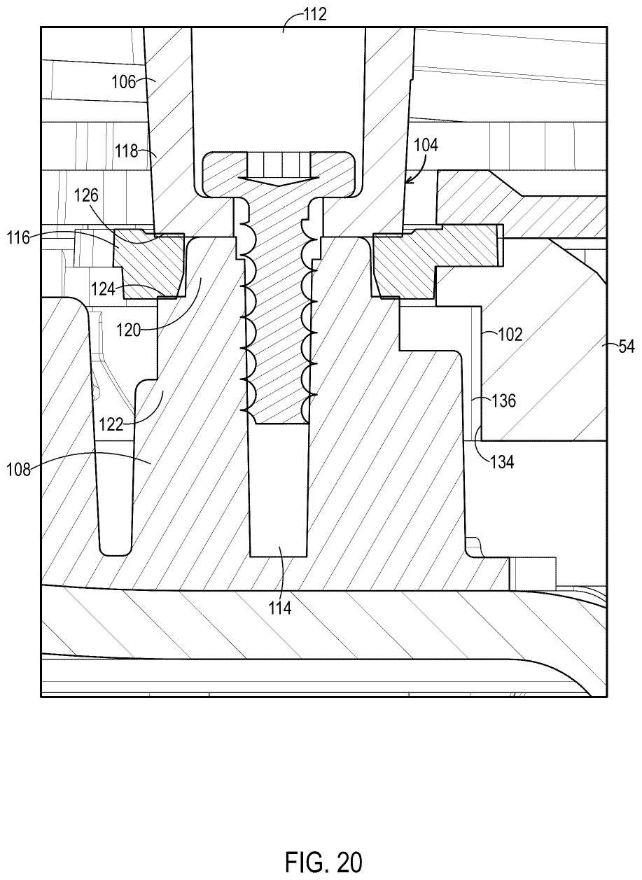

In the illustrated embodiment, each of the x-y stop assemblies 128 is closely associated with a respective mount 100, and in fact, a portion of the x-y stops 128 are integrated with the flexible mounts 100. In particular, as best illustrated in FIG. 22, the x-y stop 128a comprises a plurality of ribs 132 radially extending from the boss component 108 extending from the rear housing portion 52 (or alternatively the boss component 104 extending from the front housing portion 50) and an annular edge 134 (shown in FIG. 20) of the chassis 54 formed around the respective through-hole 102 of the chassis 54, such that the x-y stop 128a forms a nominal annular x-y clearance gap 136 between the outwardly extending ribs 132 of the boss component 108 and the annular edge 134 of the chassis 54, as best shown in FIG. 20. As best illustrated in FIG. 23, each of the z stops 128b is closely associated, but not integrated, with a respective mount 100. In particular, the z stop 128b comprises a protuberance 140 extending from the front housing portion 50 and a recess 142 formed in the chassis 54 of the VOA 40 in alignment with the protuberance 140, such that the z stop 128b forms a nominal z clearance gap 144 between the protuberance 140 and the recess 142. Although the z stop 128b is illustrated as being separate from the x-y stop 128a, it should be appreciated that a z stop can be alternatively or additionally integrated with the x-y stop 128a.

It can be appreciated that the x-y clearance gap 136 and the z clearance gap 144 provide clearance between the chassis 54 and the relatively rigid boss 104 and inner surfaces of the rear housing portion 52 and front housing portion 50 do not come in contact in response to the application of a static deformation load to the frame front 34. In this manner, any mechanical conduction path that communicates the static deformation load applied to the frame front 34 to the chassis 54 can be avoided. Instead, substantially all of static deformation load applied to the frame front 34 will be absorbed by the compliant bushings 108 of the flexible mounts 100. The nominal sizes of the x-y clearance gap 136 and the z clearance gap 144 are preferably sufficiently great enough, such that as a static deformation load is applied to the frame front 34, the x-y clearance gap 136 and the z clearance gap 144 do not completely close in a manner that chassis 54 and relatively rigid boss 104 and inner surfaces of the rear housing portion 52 and front housing portion 50 do not come in contact with each other. Notably, the nominal sizes of the x-y clearance gap 136 and the z clearance gap 144 may be tuned (i.e., made larger or smaller) based on the magnitude of the static deformation load anticipated to be applied to the frame front 34. That is, the x-y clearance gap 136 and the z clearance gap 144 may be made larger as the magnitude of the static deformation load anticipated to be applied to the frame front 34 increases, and may be made smaller as the magnitude of the static deformation load anticipated to be applied to the frame front 34 decreases.

In contrast, in response to the application of a dynamic deformation load to the frame front 34, the clearance gap 136 and z clearance gap 144 will completely close, such that chassis 54 and makes contact with the relatively rigid boss 104 and inner surfaces of the rear housing portion 52 and front housing portion 50 at the strategic locations oof the chassis 54. In particular, the ribs 132 and the annular edge 134 of the chassis 54 move relative to each other along the plane of the chassis 54 (x-y plane) until the x-y clearance gap 136 closes (i.e., the ribs 132 and the annular edge 134 contact each other) in response to the application of a dynamic deformation load to the frame front 34 in the direction parallel to the x-y plane. Similarly, the protuberance 140 and the recess 142 move relative to each other perpendicular to the plane of the chassis 54 (z-axis) until the z clearance gap 144 closes (i.e., the protuberance 140 and the recess 142 contact each other) in response to the application of a dynamic deformation load to the frame front 34 in a direction perpendicular to the x-y plane (i.e., along the z-axis).

It should be appreciated that, although designed to contact the VOA 40 in response to the application of a dynamic distortion load to the frame front 34, it is possible for at least one of the rigid stop assemblies 128 to contact the VOA 40 in response to the application of a static deformation load to the frame front 34. Although the flexible mounts 100 adjacent the rigid stop assemblies 128 that contact the VOA 40 will become inoperable, the flexible mount 100 that is adjacent any rigid stop assembly 128 that does not contact the VOA 40 in response to the application of a static deformation load to the frame front 34 will remain operable, and will thus, continue to prevent at least a portion of the static deformation load applied to the frame front 34 from being mechanically communicated to the VOA 40. Thus, only the application of the most severe load deformation (e.g., a dynamic load deformation caused by a drop or impact) to the frame front 34 will causes enough of the rigid stops 108 to contact the VOA 40 to over-constrain the flexible mounts 100 will impart significant deformation loads to the VOA 40.

Each of the rigid stop assemblies 130 comprises an x-y-z stop 130a configured for communicating the dynamic deformation load applied to the frame front 34 in a direction parallel with the plane of the chassis 54 and in a direction perpendicular to the plane of the chassis 54. Unlike the rigid stops 128, the rigid stop assemblies 130 are not closely associated with the flexible mounts 100, but rather are disposed remotely from the flexible mounts 100 around the bridge of the frame front 34 (i.e., around the bridge portions 72, 74 of the front and rear housing portions 50, 52).

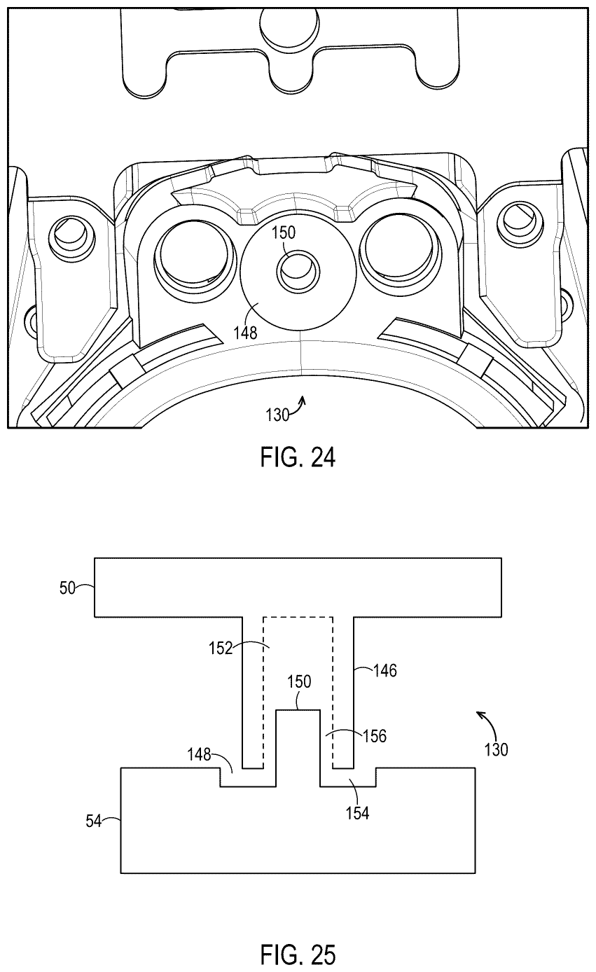

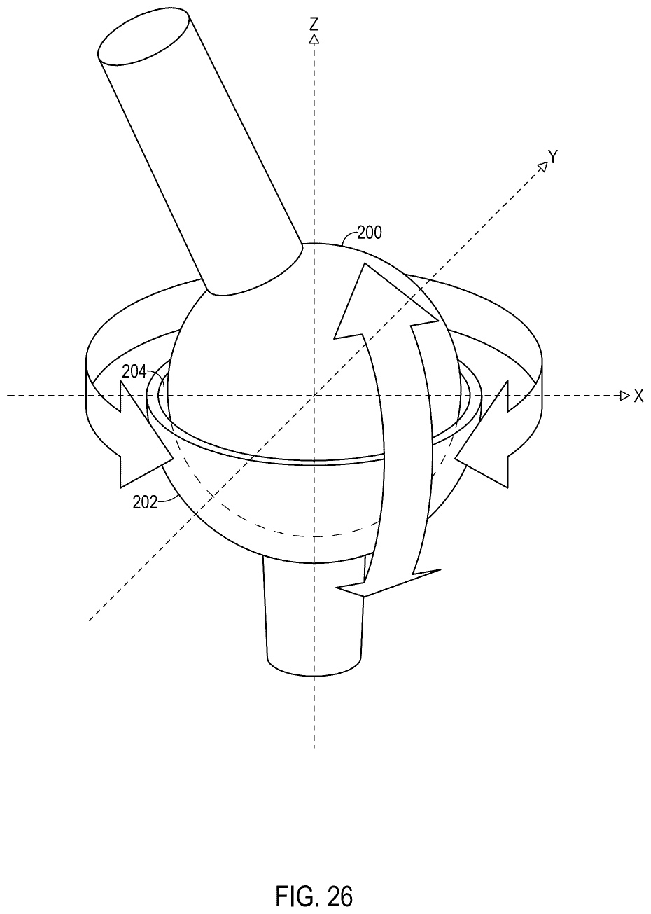

As illustrated in FIGS. 24-25, each of the rigid stop assemblies 130 comprises an annular boss 146 extending from the front housing portion 50 and a circular recess 148 formed in the chassis 54 of the VOA 40 in alignment with the annular boss 146, such that a nominal z clearance gap 154 is formed between the annular boss 146 and the circular recess 148. Each of the rigid stop assemblies 130 also comprises an annular boss 150 extending from the circular recess 148. The annular boss 146 includes a cylindrical cavity 152 in which the annular boss 150 is disposed. The diameter of the annular boss 150 is less than the diameter of the cylindrical cavity 152, such that a nominal annular x-y clearance gap 156 is formed between the cylindrical cavity 152 and the annular boss 150. The annular boss 150 and cylindrical cavity 152 move relative to each other parallel to the plane of the chassis 54 (along the x-y plane) until the x-y clearance gap 156 closes (i.e., the annular boss 150 and cylindrical cavity 152 contact each other) in response to the application of a dynamic deformation load to the frame front 34 in a direction parallel to the x-y plane. The annular boss 146 and the circular recess 148 move relative to each other perpendicular to the plane of the chassis 54 (z-axis) until the z clearance gap 154 closes (i.e., the annular boss 146 and the circular recess 148 contact each other) in response to the application of a dynamic deformation load to the frame front 34 in a direction parallel to the x-y plane.

It should also be noted that the flex cables 44 that are coupled to the chassis 54 may apply a biasing force between the frame front 34 and the VOA 40 that changes the nominal sizes of the x-y clearance gaps 136, z clearance gaps 142, x-y clearance gaps 156, and z clearance gaps 154 from their desired values. In this case, the flexible mounts 100 may be configured for applying an opposing biasing force between the frame front 34 and the VOA 40 that maintains the sizes of the nominal clearance gaps 94a, 94b at their desired values. For example, the axial location of the relatively rigid boss 104 at which the compliant bushing 116 is affixed may be selected to create this opposing biasing force.

As illustrated in FIG. 26, each of the flexible mounts 100 may be considered a “sloppy” ball joint, with the compliant bushing 116 serving as a ball 200, the rigid boss 104 serving as a cup 202, and the nominal clearance gaps 136, 142 serving as a small radial gap 204 between the ball 200 and the cup 202. The ball 200 is free to rotate about all three orthogonal x-, y-, and z-axes, and is free to linearly translate small amounts (slop) along all three of the orthogonal x-, y-, and z-axes.

As such, in some embodiments, an eyewear device (e.g., AR, VR, or MR headset) is provided. The eyewear device includes a housing (or frame) and an optical assembly (e.g., the VOA described above) at least partially contained (or positioned) within the housing. The optical assembly includes a chassis and a plurality of optical components affixed (or connected or mounted) to the chassis. The chassis (and/or the optical assembly as a whole) has a first rigidity such that when a first force is applied between a first portion of the optical assembly and a second portion of the optical assembly, at least one of the plurality of optical components moves relative to at least another of the plurality of optical components. The eyewear device also includes at least one flexible member or mount (e.g., a plurality of flexible members/mounts) interconnecting the optical assembly and the housing and having a second rigidity such that when a second force is applied between the housing and the optical assembly, the optical assembly moves relative to the housing. The first rigidity is greater than the second rigidity, and the first force is greater than the second force.

In some embodiments, when the second force is applied between the housing and the optical assembly, the entire optical assembly moves relative to the housing (e.g., the entire/each portion of the housing). In some embodiments, at least a portion of the housing has a third rigidity, the third rigidity being greater than the second rigidity.

In some embodiments, the first and third rigidities are greater than the second rigidity such that the optical assembly may move relative to the housing without the chassis of the optical assembly or the housing being deformed, bent, etc.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

1. An eyewear device for being worn on a head of a user for presenting virtual content to a user, comprising:
a frame structure having a frame front;
an optical assembly having a first rigidity, the optical assembly having a chassis and a plurality of optical components affixed to the chassis; and
a plurality of mounts mechanically coupling the chassis of the optical assembly to the frame front, at least one of the plurality of mounts having a second rigidity less than the first rigidity, such that the at least one mount is configured for preventing at least a portion of a first static deformation load applied to the frame front from being mechanically communicated to the optical assembly.

2. The eyewear device of claim 1, wherein each of the plurality of mounts has a second rigidity less than the first rigidity, such that the plurality of mounts are configured for preventing the at least portion of the first static deformation load applied to the frame front from being mechanically communicated to the optical assembly.

3. The eyewear device of claim 1, wherein the at least one mount is configured for preventing the at least portion of the first static deformation load applied to the frame front from being mechanically communicated to the optical assembly, such that the entire optical assembly translates relative to the frame front in response to the application of the first static deformation load to the frame front.

4. The eyewear device of claim 3, wherein the at least one mount is configured for maintaining the optical assembly at a nominal position relative to the frame front in the absence of the application of the first static deformation load to the frame front, preventing the at least portion of the first static deformation load applied to the frame front from being mechanically communicated to the optical assembly, such that the entire optical assembly translates from the nominal position to a new position relative to the frame front in response to the application of the first static deformation load to the frame front, and allowing the entire optical assembly to translate from the new position back to the nominal position relative to the frame front in response to a cessation of the application of the first static deformation load to the frame front.

5. The eyewear device of claim 1, wherein the plurality of optical components are configured for moving relative to each other in response to an application of a second static deformation load to the optical assembly, and wherein the application of the first static deformation load to the frame front causes a third static deformation load to be applied to the optical assembly, the first static deformation load being higher than the second static deformation load, and the third static deformation load being less than the second static deformation load.

6. The eyewear device of claim 1, wherein the frame front has a third rigidity greater than the second rigidity of the at least one mount.

7. The eyewear device of claim 1, wherein the plurality of mounts mechanically couple a periphery of the chassis to the frame front.

8. The eyewear device of claim 1, wherein the chassis comprises at least one through-hole, and each of the at least one mount comprises a relatively rigid boss extending from the frame front through a respective one of the at least one through-hole of the chassis, and a compliant bushing coaxially disposed between the respective aperture of the chassis and the respective relatively rigid boss.

9. The eyewear device of claim 8, wherein the compliant bushing is composed of an elastomeric material.

10. The eyewear device of claim 8, wherein the frame front comprises a front housing portion and a rear housing portion, each of relatively rigid boss has a first boss component extending from the front housing portion and a second boss component extending from the rear housing portion, and each of the at least one mount further comprises a fastener that affixes the respective first boss component to the respective second boss component, thereby affixing the front housing portion and rear housing portion to each other.

11. The eyewear device of claim 8, wherein the frame structure comprises a pair of temple arms affixed to the frame front.

12. The eyewear device of claim 1, further comprising at least one flex cable coupled to the chassis of the optical assembly, wherein the at least one flex cable asserts a first biasing force between the frame front and the optical assembly, and wherein the at least one mount is configured for applying a second biasing force between the frame front and the optical assembly, the second biasing force opposing the first biasing force.

13. The eyewear device of claim 1, wherein the at least one mount is configured for preventing at least fifty percent of the first static deformation load applied to the frame front from being mechanically communicated to the optical assembly.

14. The eyewear device of claim 1, wherein the at least one mount is configured for preventing at least seventy-five percent of the first static deformation load applied to the frame front from being mechanically communicated to the optical assembly.

15. The eyewear device of claim 1, wherein the at least one mount is configured for preventing the at least portion of the static deformation load applied to the frame front from being mechanically communicated to the optical assembly in a direction perpendicular to a plane of the chassis.

16. The eyewear device of claim 1, wherein the at least one mount is configured for preventing the at least portion of the static deformation load applied to the frame front from being mechanically communicated to the optical assembly in a direction parallel to a plane of the chassis.

17. The eyewear device of claim 1, further comprising a plurality of rigid stops configured for creating a plurality of contact points in response to a dynamic deformation load applied to the frame front, such that at least a portion of the dynamic deformation load applied to the frame front is communicated to the chassis through the plurality of contact points.

18. The eyewear device of claim 17, wherein the at least portion of the dynamic deformation load is communicated to the chassis through the plurality of contacts in a direction perpendicular to a plane of the chassis.

19. The eyewear device of claim 17, wherein the at least portion of the dynamic deformation load is communicated to the chassis through the plurality of contacts in a direction parallel to the plane of the chassis.

20.-24. (canceled)

25. An eyewear device for being worn on a head of a user for presenting virtual content to a user, comprising:
a frame structure having a frame front;
an optical assembly having a first rigidity, the optical assembly having a chassis and a plurality of optical components affixed to the chassis; and
a plurality of mounts mechanically coupling the chassis of the optical assembly to the frame front, wherein at least one of the plurality of mounts is configured for preventing at least portion of a first static deformation load applied to the frame front from being mechanically communicated to the optical assembly, such that the entire optical assembly translates relative to the frame front in response to the application of the first static deformation load to the frame front.

26.-44. (canceled)
